(19) United States
(12) Patent Application Publication
(10) Pub. No.: US 2022/0309256 A1
(43) Pub. Date: Sep. 29, 2022

(54) DEVICE AND METHOD FOR PERSONALIZING SECURITY OR IDENTIFICATION OBJECTS

(71) Applicant: Muehlbauer GmbH & Co. KG, RODING (DE)

(72) Inventor: Hubert Dabrowski, Chemnitz (DE)

(21) Appl. No.: 17/606,131

(22) PCT Filed: Apr. 20, 2020
(86) PCT No.: PCT/EP2020/060987

§ 371 Date: Oct. 25, 2021

(30) Foreign Application Priority Data
Apr. 26, 2019 (DE) 102019003028.1

(51) Int. Cl. G06K 1/12; B41M 5/26; B42D 25/435; B42D 25/30; B42D 25/23

(52) U.S. Cl. CPC G06K 1/126; B41M 5/26; B42D 25/435; B42D 25/30; B42D 25/23

(57) ABSTRACT

A device for personalizing security or identification objects including a laser processing station having a laser unit that personalizes an object located in a laser processing area. The laser processing station comprises a turntable with a first receiving area for receiving a first object and a second receiving area for receiving a second object. The turntable is mounted rotatably relative to the laser unit so that it can be rotated from a first rotational position into a second rotational position. In the first rotational position, the first object and in the second rotational position the second object are at least partially located in the laser processing area.

### CROSS-REFERENCE TO RELATED APPLICATIONS

This application is a National Stage application of International Application No. PCT/EP2020/060987 filed on Apr. 20, 2020 which claims priority to German Patent Application Serial No. DE 10 2019 003 028.1 filed Apr. 26, 2019.

### BACKGROUND

### Field

The present application relates to a device for personalizing security or identification objects, in short SI objects, with at least one laser processing station, wherein the laser processing station has a laser unit which is set up to personalise an SI object located in a laser processing area by means of laser irradiation.

SI objects can be cards, such as ID cards, EC cards, or identity documents, such as ID cards, passports, access and other authorisation documents.

### Discussion of the Related Art

It is known to use processing stations arranged serially in a production line for machining SI objects. Processes using processing stations arranged in parallel is also known. This enables a particularly high throughput.

SI items often have so-called personalization data, which are text, numerical and/or image data that relate individually to the holder of the SI item. Examples of personalisation data are the name and address of the holder, date of birth, place of birth, photograph of the holder, biometric data, etc. Usually, SI items are initially manufactured except for the personalisation data and subsequently personalised with the personalisation data.

In order to provide an SI object with personalization data, it is known to irradiate the SI object with a laser in a laser processing station to produce a laser engraving. For the preparation of the laser irradiation, the SI object is arranged in a laser processing area of the laser processing station and aligned in a defined manner so that the subsequent laser irradiation of the SI object can take place in a specific spatial allocation. In addition, the desired data relating to the laser engraving must be fed to the laser as control signals for the laser. After laser irradiation, the SI object must then be removed again from the laser processing station.

Such a laser irradiation for personalizing an identity card can take up to more than 20 seconds—depending on the laser used and the layout of the engraving. Thus, including the mentioned preparatory and post-processing procedures, the laser processing of an SI object in the laser processing station takes a relatively long time.

DE 20 2005 012 928 U1 describes a portable personalization device for labelling data carriers by means of an integrated laser unit. Different cassette units can be inserted into the device from the front. Each cassette unit is adapted to a specific shape and a specific type of data carrier to be inscribed. Thus, the personalisation device is suitable for labelling differently shaped data carriers, such as plastic cards or passports.

DE 10 2004 062 839 A1 describes a device for contactless personalization of chips integrated in passport books within a system for processing, sorting and/or packaging a large number of passport books. The passport books are transported along a main transport path in a first transport direction to a system module for personalization and are diverted there by means of shifting devices to first secondary transport paths on which they are transported perpendicular to the first transport direction. The passports are then moved by means of movable transport elements—parallel to the first transport direction—via encoding stations in which they are positioned and then personalised by means of electronic contactless encoding of the chips. Subsequently, the personalised passports are guided—perpendicular to the first transport direction—on second secondary transport paths back to the main transport path. The device thus enables the chips to be encoded with a high throughput.

From DE 10 2006 019 785 A1 a device for encoding chip cards is known, which has a feed path for the chip cards, as well as several processing paths oriented parallel to the feed path with encoding stations for encoding the cards. A transfer station is used to distribute the chip cards to the processing tracks, in which the chip cards transported along the feed track are distributed to two card carriages, via which the chip cards are transported on to the individual processing tracks on two sides perpendicular to the feed track. By using two card slides, the chip cards can be distributed to the processing lanes with a particularly high throughput.

EP 1 507 231 A1 describes adaptation elements for programmable electronic carriers and the application of the adaptation elements in a universal device for personalizing programmable electronic carriers. The adaptation elements are conveyed through the universal device for personalisation by a rotating disc which accommodates several adaptation elements. In a labelling station, the programmable electronic carriers of the adaptation elements are successively labelled with laser printing.

WO2009/144 571 A1 describes a device for matching electronic components. In a marking system, several electronic components picked up on a rotating plate are marked one after the other with a laser.

A personalization device should allow for a particularly high personalisation throughput with the lowest possible manufacturing effort and the smallest possible design. It can therefore be seen as a task to specify a corresponding device that can be designed effectively, simply and compactly. In addition, a method for personalisation is to be specified which is particularly effective.

### SUMMARY

This task is solved with a device according to the independent claims. Embodiments are given in the dependent claims.

For this purpose, according to the present application, a device for personalizing SI objects is provided, which has at least a first laser processing station. The laser processing station has a laser unit which is set up to personalise an SI object located in a laser processing area by means of laser irradiation. The laser processing station has a turntable with a first receiving area for receiving a first SI object and a second receiving area for receiving a second SI object. The turntable is rotatably mounted relative to the laser unit about an axis of rotation so that it can be rotated from a first rotational position to a second rotational position. In the first rotational position of the turntable, the first SI object received in the first receiving area is at least partially located in the laser processing area, and in the second rotational position of the turntable, the second SI object received in the second receiving area is at least partially located in the laser processing area.

In this way, the laser irradiation of the first SI object located in the first receiving area can take place, while steps for preparing the laser irradiation as such using the second receiving area are carried out for the second SI object overlapping in time. In particular, this may comprise loading the second SI object into the second receiving area and detecting the position of the second SI object in the second receiving area. In a subsequent step, the turntable may be rotated from the first rotational position to the second rotational position such that the second SI object is then at least partially located in the laser processing region. During the rotation, the position information can be transmitted to the laser unit. Now the laser irradiation of the second SI object can take place using the transmitted position information. Overlapping in time, the first SI object can be removed or discharged from the first recording area.

Subsequently—still during the laser irradiation of the second SI object—a third SI object can be loaded into the then again free first receiving area, and so on. In this way, the laser unit can be used particularly well in terms of time.

The steps mentioned for preparing the laser irradiation of an SI object and the removal of the SI object after laser irradiation is completed are also referred to here as “secondary steps”. The times required to perform the secondary steps are referred to as “secondary times”.

The SI items are in particular SI items of the same kind or identical shape. In one variant, they are booklets, for example passports.

In one variant, the laser processing station has a housing, wherein the laser unit and the rotation axis are fixed in position relative to the housing. For example, in one variant the rotation axis is oriented vertically. In one embodiment, the laser unit is arranged above the turntable, in particular vertically above the laser processing area. In one embodiment, the turntable is shaped such that it extends at least in a first approximation in a plane oriented normal to the axis of rotation.

In particular, the design is such that when the turntable is in the first rotational position, the laser processing area does not extend into the second receiving area.

The apparatus has a laser irradiation preparation unit for preparing a laser irradiation, wherein the laser irradiation preparation unit is set up to detect a position of the second SI object received in the second receiving area in the first rotational position of the turntable and to transmit information about the detected position to the laser unit. The laser unit is designed to use the transmitted information as an input variable for a subsequent laser irradiation of the second SI object. For controlling the processes described here, the device has in particular a control unit.

The laser irradiation as such typically takes longer than the non-productive times. Therefore, in one variant, the turntable has only two holding areas. Thus, one pick-up area can be used for laser irradiation at the same time, while the other can be used for the secondary steps. Thus, another pick-up area would not save any further time and would only result in a larger design of the turntable. Therefore, the turntable and thus also the entire laser processing station can be designed in a particularly space-saving way if the total number of pick-up areas of the turntable is only two.

In one variant, the first receiving area and the second receiving area are symmetrical with respect to the axis of rotation.

According to one embodiment, the turntable may be rotated from the first rotational position to the second rotational position by a rotation of 180°±10° about the axis of rotation. In this way, the turntable can be designed in such a way that—when viewed along the axis of rotation—one half of the turntable is essentially occupied by the first receiving area and the other half is essentially occupied by the second receiving area. In this way, the turntable as a whole can be made particularly compact.

Alternatively, the turntable has more than two receiving areas, for example three or four corresponding receiving areas. The rotation from the first rotational position to the second rotational position then takes place accordingly, for example by 120° in the case of three receiving areas, by 90° in the case of four receiving areas, and so on.

According to one embodiment, the turntable has a first support area and a first cover area to form the first receiving area, such that the first SI item received in the first receiving area is located between the first support area and the first cover area, and a second support area and a second cover area to form the second receiving area, such that the second SI item received in the second receiving area is located between the second support area and the second cover area. The receiving and cover regions can form a type of pocket, whereby the SI objects can be transported particularly easily into the relevant receiving region for loading and can also be removed from the receiving region again for unloading. This is particularly advantageous in the case of SI items in the form of a booklet. In one embodiment, the design is such that the booklet is received or loaded into the receiving area in an opened state. In one variant, the support area has a groove for receiving a collar area of the booklet.

According to one embodiment, the first cover area has a window area and the second cover area has a window area, wherein in the first rotational position of the turntable, the first window area at least partially encloses the laser processing area. In this way, it can be achieved that a laser beam emitted from the laser reaches the SI object practically unattenuated.

In one embodiment, the turntable further has a first clamping member movable back and forth between a clamping position and an open position, wherein in the clamping position of the first clamping member, the first SI item received in the first support portion is pressed by the first clamping member against an edge portion of the window portion of the first deck portion, thereby fixing the first SI item in the first support portion. In the open position of the first clamping element, the first SI object is movable between the first support area and the first cover area. Further, in this embodiment, the turntable has a second clamping member movable back and forth between a clamping position and an open position, wherein in the clamping position of the second clamping member, the second SI article received in the second support region is pressed against an edge region of the window region of the second deck region by the second clamping member, thereby fixing the second SI article in the second support region. In the open position of the second clamping element, the second SI object is movable between the second support area and the second cover area.

In this way, it is possible to achieve that an SI object is particularly suitably fixed in the receiving area by the respective clamping element during laser irradiation. In the open position, loading and unloading of the holding area is particularly suitable.

In one embodiment, the clamping elements are mounted in such a way that they can be moved from the open position to the clamping position by a movement parallel to the axis of rotation.

According to one embodiment, the clamping elements have a clamping surface intended for contact with an SI object which, when viewed along the axis of rotation, is slightly larger than the relevant window area. In this way, a particularly secure clamping or fixing of the SI object can be achieved. However, depending on the type and/or size of the SI object, the clamping surface can alternatively be smaller than or the same size as the window area.

In one variant, the laser processing station also has a gripping element which is arranged to move the second clamping element back and forth between the open position and the clamping position in the first rotary position of the turntable. In preparation for a loading process, the clamping element in question can be moved to the open position by the gripping element. In this state, an SI object can be inserted, for example pushed, unhindered between the support area and the cover area of the relevant receiving area. As soon as the SI object is inserted, i.e. the receiving area is loaded, the clamping element can be moved into the clamping position by the gripping element. The SI object is then suitably fixed.

In one variant, at least one spring element is provided that presses the clamping element into the clamping position. For example, the at least one spring element can be provided acting between the relevant support area and the clamping element. Without the action of the gripping element, an SI object located in the respective receiving space is thus fixed.

According to one embodiment, the device or the laser processing station also has a loading unit which is arranged, in the first rotational position of the turntable, to push the second SI object along a first direction into the second receiving area in order to load the second receiving area, and to push the second SI object along a second direction, opposite to the first direction, out of the second receiving area in order to unload the second receiving area. In this way, it is possible to load an SI object into a receiving area on the same side of the turntable and also to remove or unload it again from the receiving area. This is advantageous because it enables a particularly space-saving design.

In one embodiment, the loading unit has a first slide for pushing the SI object into the receiving area, i.e. for loading, and/or a second slide for pushing the SI object out of the receiving area, i.e. for unloading the receiving area.

According to one embodiment, the turntable has a first alignment element configured to align an SI item in a defined manner as it is pushed through the loading unit into the first receiving area and a second alignment element configured to align an SI item in a defined manner as it is pushed through the loading unit into the second receiving area.

According to one embodiment, the device also comprises at least one further laser processing station which is designed analogously to the first laser processing station, as well as a transport device which is set up to feed SI objects alternately to the first and the at least one further laser processing station. In this way, parallel laser processing of the SI objects can be achieved and thus a further increase in throughput.

In one variant, the transport device is set up to feed the SI objects to the loading unit of the relevant laser processing station in each case.

In one variant, the transport device has a main transport path and two distribution transport paths running perpendicular to the main transport path, the transport device being set up to feed the SI objects to the laser processing stations via the main transport path and the two distribution transport paths and to transport the SI objects from the laser processing stations back to the main transport path.

According to one embodiment, the two distribution transport paths extend on two opposite sides with respect to the main transport path.

In one variant, the distribution transport paths each lead to at least two laser processing stations, for example to four laser processing stations each.

Furthermore, in one variant, the transport device also has a separating unit arranged between the main transport path and the distribution transport paths, via which the SI objects are transported alternately from the main transport path to the two distribution transport paths. This makes it possible to transport an SI object via the first distribution transport path to a laser processing station, whereby an SI object that follows the SI object next can already be directed to the second distribution transport path before the first distribution transport path is free again to receive another SI object. In this way, the throughput can be increased.

Furthermore, according to one embodiment, a connection unit is provided through which the finished personalised SI items that are transported back through the two distribution transport paths are guided back onto the main transport path.

According to a further aspect of the application, there is provided a method of personalizing SI articles having at least a first laser processing station, comprising the steps of:

(a) placing a first SI object in a first receiving area of a turntable of the laser processing station;

(b) placing a second SI object in a second receiving area of the turntable;

(c) laser irradiating the first SI object received in the first receiving area for personalisation when the turntable is in a first rotational position by means of a laser unit of the laser processing station;

(d) rotating the turntable from the first rotational position to a second rotational position;

(e) laser irradiating the second SI object received in the second receiving area for personalisation when the turntable is in the second rotational position by means of the laser unit.

In one variant, step (b) is carried out overlapping in time with step (c).

The method also includes the following step:

(f) detecting a position of the second SI object received in the second receiving area when the turntable is in the first rotational position and using information about the position in step (e).

In one variant, step (f) is carried out overlapping in time with step (c).

In step (d), the turntable is rotated by 180°±10°.

In one variant, in step (b), in the first rotational position of the turntable, the second SI object is pushed along a first direction into the second receiving area and, in a further step (g), in the first rotational position of the turntable, the second SI object is pushed along a second direction opposite to the first direction out of the second receiving area.

In one variant, step (g) is carried out overlapping in time with step (c).

In step (b), the second SI object is preferably fixed in position between a second support area and a second cover area of the turntable by means of a second clamping element.

According to one embodiment, the following step is further provided:

(h) transport SI items and divide the SI items among several laser processing stations.

### BRIEF DESCRIPTION OF THE DRAWINGS

Further features, characteristics, advantages and possible variations will become clear to a person skilled in the art from the following description, in which reference is made to the accompanying drawings.

FIG. 1 shows a perspective sketch of a laser processing station;

FIG. 2 shows a perspective sketch of the rotary table of the laser processing station;

FIG. 3 shows a schematic side view of the turntable and a loading unit for loading and unloading the turntable with SI items; and

FIG. 4 shows a schematic representation of a device with several laser processing stations.

The accompanying drawings, technical content and detailed description refer to preferred embodiments, but this is not to be construed as limiting the subject-matter of the application. All equivalent variations and modifications made in accordance with the appended claims of the present application are disclosed herein.

### DETAILED DESCRIPTION OF THE EMBODIMENTS

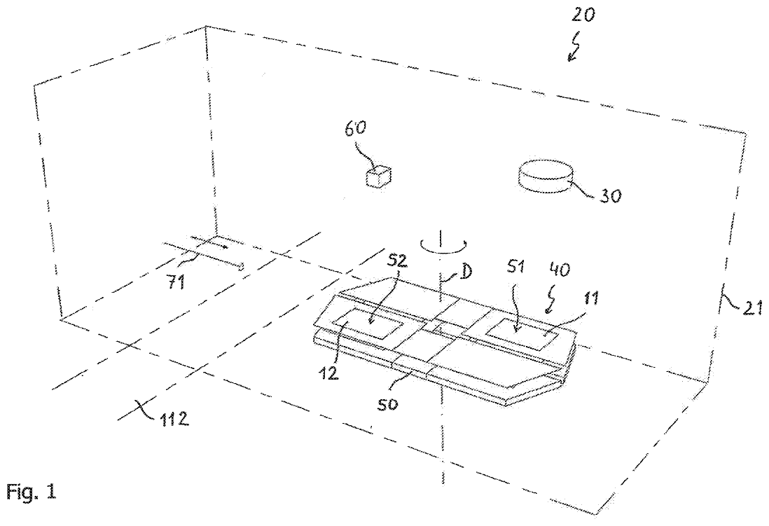

FIG. 1 schematically shows a laser processing station 20 of a device for personalizing SI items 11, 12. The SI items may in particular be booklets such as passports.

The laser processing station 20 has a laser unit 30 which is set up to personalise an SI object located in a laser processing area 40 by means of laser irradiation. The laser irradiation creates a laser engraving in the SI object.

Further, the laser processing station 20 has a turntable 50 with a first receiving area 51 for receiving a first SI object 11 and with a second receiving area 52 for receiving a second SI object 12.

The turntable 50 is mounted so that it can rotate about an axis of rotation D relative to the laser unit 30, so that it can be rotated from a first rotational position—shown in FIG. 1—into a second rotational position. The turntable 50 can be rotated from the first rotational position to the second rotational position by a rotation of 180°. In other words, the two rotational positions differ by 180°.

The laser processing station has a housing 21, which is only indicated in FIG. 1, in which the laser unit 30 is arranged in a fixed position. The turntable 50 is mounted relative to the housing 21 in such a way that the axis of rotation D is invariably oriented, in particular vertically. The laser unit 30 is arranged above the turntable 50 so that a laser beam directed downwards from the laser unit 30 reaches the laser processing area 40.

The laser processing area 40 only extends over a part of the turntable 50. In the first rotational position of the turntable 50, the second pick-up area 52 is arranged outside the laser processing area 40.

The two receiving areas 51, 52 are designed symmetrically with respect to the axis of rotation D.

In the first rotational position of the turntable 50, the first SI object 11 disposed in the first receiving area 51 is at least partially within the laser processing area 40 and the second SI object 12 disposed in the second receiving area 52 is outside the laser processing area 40.

In the second rotational position of the turntable 50, the second SI object 12 disposed in the second receiving area 52 is at least partially within the laser processing area 40 and the first SI object 11 disposed in the first receiving area 51 is outside the laser processing area 40.

Further, the laser processing station 20 has a laser irradiation preparation unit 60 for preparing a laser irradiation, wherein the laser irradiation preparation unit 60 is arranged to detect a position of the second SI object 12 received in the second receiving area 52 in the first rotational position of the turntable 50 and to transmit information about the detected position to the laser unit 30. The laser unit 30 is configured to use the transmitted information as an input variable for a subsequent laser irradiation of the second SI object 12.

In this way, an automatic layout adjustment to the detected position of the SI object in question can be achieved. This is also helpful if the SI object, e.g. a passport, should slightly rotate or slip in the pick-up area, because the SI object can be lasered without having to adjust the laser unit. In this way, rejects can be reduced overall.

In one embodiment, the laser irradiation preparation unit 60 has a camera with which an image of the second SI object 12 recorded in the second recording area 52 can be recorded for position detection. The camera is also arranged fixed in position relative to the housing 21.

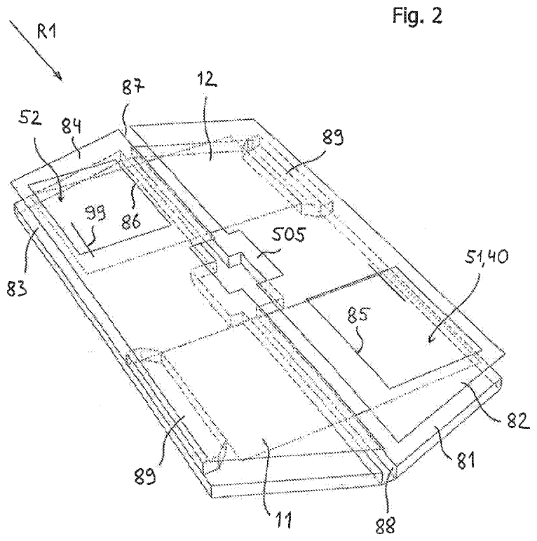

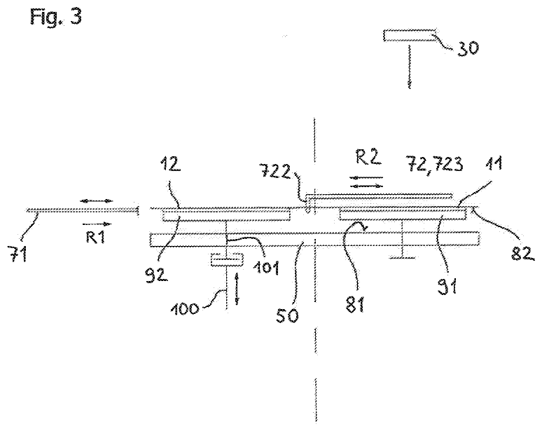

FIG. 2 shows a perspective sketch of the turntable 50 in a separated form, FIG. 3 shows the turntable 50 viewed from one side. In FIG. 2, the first SI object 11 and the second SI object 12 are indicated by dashed lines.

The turntable 50 has a first support area 81 and a first cover area 82 to form the first receiving area 51, such that the first SI object 11 received in the first receiving area 51 is located between the first support area 81 and the first cover area 82. The first support area 81 and the first cover area 82 are arranged substantially parallel to each other, so that a kind of pocket for receiving an SI object is formed between them.

Furthermore, the turntable 50 has a second support area 83 and a second cover area 84 to form the second receiving area 52, such that the second SI object 12 received in the second receiving area 52 is located between the second support area 83 and the second cover area 84. The design is symmetrical with respect to the first support region 81 and the first cover region 82.

The design is further such that an SI object can be pushed from outside into the second receiving area 52 by a rectilinear movement along a first direction R1 when the turntable 50 is in the first rotational position shown in the figures. Since the design is symmetrical with respect to the axis of rotation D, in the second rotational position of the turntable 50, an SI object can be pushed from outside into the first receiving area 51 by a rectilinear movement along the first direction R1.

As indicated in FIG. 3, for loading the receiving areas 51, 52, the laser processing station 20 has a loading unit 70 which is arranged, in the first rotational position of the turntable 50, to push the second SI object 12 into the second receiving area 52 along the first direction R1 for loading the second receiving area 52, and to push the second SI object 12 out of the second receiving area 52 along a second direction R2 opposite to the first direction R1 for unloading the second receiving area 52. In one embodiment, the loading unit 70 has a first pusher 71 for pushing an SI object in along the first direction R1 and/or a second pusher 72 for pushing an SI object out along the second direction R2. The sliders 71, 72 have at least partially a linear and/or an angled structure. In the example shown, the first slider 71 has a linear structure extending along the first direction R1. The second slider 72 has an angled, L-shaped structure so that a vertical section 722 and a horizontal section 723 of the second slider 72 are formed. Thereby, the horizontal section extends along the second direction R2. With its vertical section 722, the second slider 72 engages, in an initial rest position (sketched in FIG. 3), a free area 505 formed around the rotation axis D of the turntable 50 by the support areas 81, 83 and the cover areas 82, 84. The free area 505 has, for example, a rectangular or circular horizontal cross-section.

The design is such that during rotation of the turntable 50 from the first rotational position to the second rotational position, the vertical portion 722 of the second slider 72 can remain engaged in the clearance area 505 when the second slider 72 is in the initial rest position. The horizontal section 723 of the second slider 72 is arranged above the turntable 50, as indicated in FIG. 3.

In one embodiment, a linear drive and/or a rack-and-pinion drive is provided to drive the sliders 71, 72.

In one variant (not shown in the figures), the loading unit 70 is configured to turn an SI object 180° about an axis of rotation parallel to the first direction R1, so that the other side of the SI object can also be lasered.

For receiving a waistband area of an SI object in the form of a booklet, in the embodiment shown, a groove 88 is formed on each of the support areas 81, 83, which extends parallel to the first direction R1 (and thus also parallel to the second direction R2). Alternatively or, as is the case in the example shown, in addition, a recess 87 is formed for this purpose on each of the cover areas 82, 84, which extends parallel to the first direction R1. The grooves 88 or recesses 87 extend continuously from the edge of the turntable 50 to the free area 505.

According to one embodiment, the grooves 88 or recesses 87 are formed offset transversely to the first direction R1 in the two support areas 81, 83 or cover areas 82, 84, depending on the design of the SI objects concerned, as indicated in FIG. 2; alternatively, they are formed aligned in one line.

The grooves 88 or recesses 87 are also designed as a preferably contactless guide for the first slider 71 and/or the second slider 72. For this purpose, the grooves 88 or recesses 87—viewed transversely to the first direction R1—are at least as wide or slightly wider than the slides 71, 72. The grooves 88 or recesses 87 open into the free area 505 in the centre of the turntable 50 in such a way that the second slide 72 can engage with its vertical section 722 in the free area 505 during the rotation of the turntable 50 without hindering the rotation. For an unloading operation, the second slider 72 can be moved, starting from its initial rest position, with its vertical section 722 along the respective groove 88 or the respective recess 87 and in this way push the corresponding SI object out of the turntable 50. This design in particular eliminates the need for vertical movement of the second slider 72.

The first slider 71 can be moved along the first direction R1 for a loading operation from an initial rest position (outlined in FIG. 3), in which it does not engage in the movement space of the turntable 50, in order to convey an SI object into the turntable 50. During this movement, the first pusher 71 can engage the respective groove 88 or the respective recess 87.

This design of the interaction between the turntable 50 and the two sliders 71, 72 enables a particularly fast and at the same time gentle transport of the SI objects into and out of the turntable 50 with a compact arrangement, especially because the movement of the sliders 71, 72 partly takes place directly in the turntable 50.

In an alternative not shown, the grooves 88 or recesses 87 can be formed to merge directly into one another, i.e. without the clearance area 505.

The turntable 50 has an alignment element 89 on one side of each receiving area 51, 52, which is used to align an SI item in a defined manner on this side during the loading process. In one variant, the alignment element 89 is adjustable in its position so that it can be set to a desired width/dimension of the SI items or passports. According to another variant, the alignment element 89 is perpendicular to the first direction R1 and thereby horizontally biased, for example by a return spring. In this way, the alignment element 89 can be pushed back when loading an SI item and thus automatically adapts to the SI item or fixes it.

In one embodiment, the alignment element 89 and/or the support areas 81, 83 have at least one tapering or sloping edge area in the form of a run-up slope, by means of which loading of an SI object is facilitated and at the same time the corresponding corners and/or edges of the SI object are protected.

Furthermore, the first cover area 82 has a window area 85 and the second cover area 84 has a window area 86, wherein in the first rotational position of the turntable 50 the window area 85 of the first cover area 82 at least partially encloses the laser processing area 40. The design is thus such that—in the first rotational position of the turntable 50—the laser irradiation can take place through the window area 85 of the first cover area 82. This allows the laser radiation to reach the SI object located there unhindered or unattenuated.

In one embodiment, the cover areas 82, 84 are reversibly detachably arranged on the remaining turntable 50. In this way, the cover areas 82, 84 can be easily exchanged for corresponding further cover areas (not shown in the figures) which differ in their window areas from the cover areas 82, 84. In this way, if necessary, a suitable adaptation to a certain type and/or size of SI objects or to a certain laser layout can be achieved.

Furthermore, the turntable 50 further has a first clamping element 91 movable back and forth between a clamping position and an open position. In this case, the first clamping element 91 is mounted in such a way that it can be moved back and forth parallel to the axis of rotation D, so that it can be moved from the open position into the clamping position by a movement along this direction, for example, according to the illustration in FIG. 3, by an upwardly directed movement, and from the clamping position into the open position by a movement in the opposite direction, for example, a downwardly directed movement.

The first SI object 11 received in the first receiving area 51 in the clamping position of the first clamping element 91 is pressed by the first clamping element 91—here from below—against an edge area of the window area 85 of the first cover area 82. This fixes the first SI object 11 in the first receiving area 51. Through this fixation, the first SI object 11 can be held in position in a suitably defined manner for laser irradiation. In the open position of the first clamping element 91, on the other hand, the first SI object 11 is movable between the first support area 81 and the first cover area 82.

Further, the turntable 50 has a second clamping member 92 movable back and forth between a clamping position and an open position, wherein in the clamping position of the second clamping member 92, the second SI article 12 received in the second support portion 52 is pressed against an edge portion of the window portion 86 of the second deck portion 84 by the second clamping member 92. This fixes the second SI object 12 in the second receiving area 52, and in the open position of the second clamping element 92, the second SI object 12 is movable between the second support area 83 and the second cover area 84. In the open position of the second clamping element 92, the second SI object 12 can thus be pushed out of the second receiving area 52 in the second direction R2, for example by the second slider 72.

The laser processing station 20 further has a gripping element 100 arranged below the turntable 50, which is set up to move the second clamping element 92 back and forth between the open position and the clamping position in the first rotational position of the turntable 50. For this purpose, the gripping element 100 is mounted parallel to the axis of rotation or vertically displaceable relative to the housing 21 of the laser processing station 20. The second clamping element 92 has a downwardly directed projection 101 on its underside, which can be gripped by the gripping element 100. For this purpose, the extension 101 projects through a through-opening provided for this purpose in the second support area 83.

The design at the location of the first clamping element 91 is analogous in this respect, so that in the second rotational position of the turntable 50, the first clamping element 91 can be moved accordingly by the gripping element 100.

In one embodiment, the clamping elements 91, 92 are each biased into the clamping position by at least one spring element (not shown in the figures), so that without any action of the gripping element 100 the respective SI object is fixed by the respective clamping element 91, 92. In particular, the design may be such that during the start of rotation of the turntable 50 from the first rotational position to the second rotational position, the extension 101 is moved laterally out of the gripping element 100 so that the respective clamping element remains in the clamping position. This enables suitable fixation of the SI objects during laser irradiation.

To prevent the first SI object 11 from bulging out in the window area 85 of the first cover area 82, the turntable 50 has a bracket 99 that is attached to the edge area of the window area 85 and presses the SI object towards the first clamping element 91. The bracket 99 is designed in such a way that it does not protrude into an area intended for laser engraving. The bracket 99 ensures a particularly high accuracy for the layout of the laser engraving.

A corresponding further bracket 99 is provided on the second deck area 84.

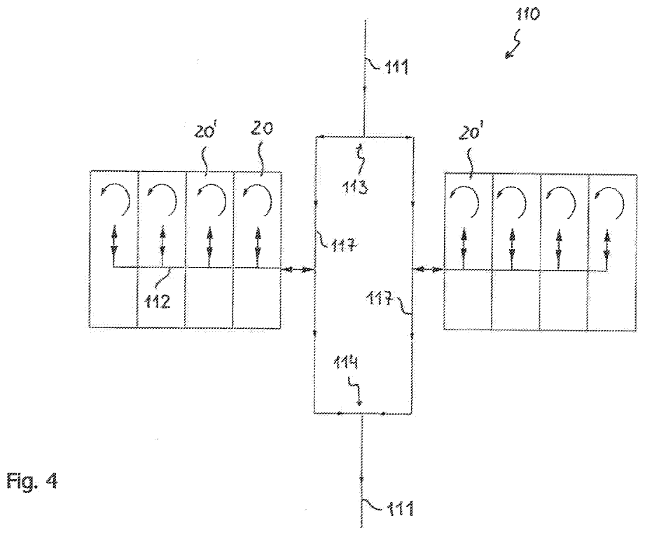

FIG. 4 shows an example of a device that has at least one further laser processing station 20′ in addition to the laser processing station 20. As an example, a case with a total of eight laser processing stations 20, 20′ is sketched here. The at least one further laser processing station 20′ is designed analogously to the first laser processing station 20.

The apparatus comprises a transport device 110 arranged to—alternately feed SI objects to the first and the at least one further laser processing station 20, 20′.

The transport device 110 is arranged to feed the SI objects—respectively to the loading unit 70 of the respective laser processing station 20, 20′, so that the SI objects can be loaded into the two receiving areas 51, 52 of the respective turntable 50, as described above. After a rotation of the turntable 50, the laser irradiation takes place, by which the SI objects are personalised. After a further rotation of the turntable 50, the SI objects are unloaded again from the turntable 50 by the loading unit 70. In FIG. 4, loading and unloading are each indicated by a double arrow, and the rotation of the respective turntable 50 is indicated by an arc-shaped arrow.

The transport device 110 has a main transport path 111, as well as two distribution transport paths 112 running at least transversely or perpendicularly to the main transport path 111. The transport device 110 is set up to feed the SI objects to the laser processing stations 20, 20′ or their loading units 70 via the main transport path 111 and the two distribution transport paths 112, and to transport the SI objects from the laser processing stations 20, 20′ back to the main transport path 111. In a variant for high throughput, the two distribution transport paths 112 each lead to at least two laser processing stations 20, 20′. In FIG. 1, the corresponding distribution transport path 112 leading to the first laser processing station 20 is indicated by a dashed line.

For a particularly suitable distribution of the SI items to the two distribution transport paths 112, the device also has a separating unit 113 arranged between the main transport path 111 and the distribution transport paths 112, via which the SI items are transported from the main transport path 111 alternately via parallel transport paths 117 to the two distribution transport paths 112. In this case, a connecting unit 114 is also provided, via which the finished personalised SI items are directed from the distribution transport paths 112 back onto the main transport path 111.

The transport device 110 may have guides that are used to hold SI items in the form of booklets in an open state during transport.

In one variant, the transport paths 111, 112, 117 have endless toothed belts. In one embodiment, the belts on the transport paths 111 and 117 have drivers for moving the SI objects, whereby for transport it is provided in particular that the SI objects are located in each case between the drivers. In one variant, a pneumatic element is provided for changing a transport direction, for example at a transition from one of the parallel transport paths 117 to the subsequent distribution transport path 112.

In one variant, the apparatus further has at least one further processing unit for further processing of the SI objects or at least one control unit for control of the SI objects arranged along the main transport path 111 before or after the laser processing stations 20, 20′.

A method for personalizing SI articles with at least a first laser processing station comprises the following steps:

(a) placing a first SI object 11 in a first receiving area 51 of a turntable 50 of the laser processing station 20;

(b) arranging a second SI object 12 in a second receiving area 52 of the turntable 50;

(c) laser irradiating the first SI object 11 received in the first receiving area 51 for personalisation when the turntable 50 is in a first rotational position, by means of a laser unit 30 of the laser processing station 20;

(d) rotating the turntable 50 from the first rotational position to a second rotational position;

(e) laser irradiating the second SI object 12 received in the second receiving area 52 for personalisation when the turntable 50 is in the second rotational position, by means of the laser unit 30.

In one variant, the following step is also provided for:

(f) detecting a position of the second SI object 12 received in the second receiving area 52 when the turntable 50 is in the first rotational position and using information about the position in step (e).

For the temporal sequence, the following sequence is provided in a variant. The dots each stand for a temporal phase, whereby the sequence of the dots corresponds to the temporal sequence of the phases.
setting the turntable 50 to the second rotational position
loading a first SI object into the first pick-up area 51 (in step (a))
detecting the position of the first SI object in the first recording area 51 by means of the laser irradiation preparation unit 60 and generating corresponding position information
rotating the turntable from the second rotational position to the first rotational position (FIGS. 1 to 3 show the first rotational position)
laser irradiating the first SI object using the position information (in step (c)) and

loading a second SI object into the second receiving area 52 (in step (b)) and

detecting the position of the second SI object in the second receiving area 52 by means of the laser irradiation preparation unit 60 and generating corresponding position information (in step (f))
rotating the turntable 50 from the first rotational position to the second rotational position (in step (d))
laser irradiating the second SI object using the position information (in step (e)) and

unloading the first SI object from the first receiving area 51 and

loading a third SI object into the first receiving area 51 and

detecting the position of the third SI object in the first receiving area 51 by means of the laser irradiation preparation unit 60 and producing corresponding position information
rotating the turntable 50 from the second rotational position to the first rotational position etc.

In one embodiment, the turntable 50 is rotated in opposite directions so that the turntable 50 rotates back and forth between the two rotational positions. Alternatively, the rotations take place in the same direction of rotation, so that the turntable 50 is rotated further with each rotation.

In one embodiment, the transmission of the corresponding position information takes place in each case during the rotation of the turntable 50.

Furthermore, in a variant for loading, in step (b), in the first rotational position of the turntable 50, the second SI object 12 is pushed along the first direction R1 into the second receiving area 52 and, in a further step (g), in the first rotational position of the turntable 50, the second SI object 12 is pushed along a second direction R2,—opposite to the first direction R1, out of the second receiving area 52. In one embodiment, the above-mentioned sliders 71, 72 are used for this purpose.

In a device with several laser processing stations 20, 20′, the following step is also provided in a variant:

(h) transporting SI items and distributing the SI items to several laser processing stations 20, 20′.

With the device described, it is possible to keep the number of laser processing stations used in parallel particularly low. By using several laser processing stations working in parallel, the limiting influence of non-productive times on the throughput can be kept particularly small or practically eliminated.

At the same time, the device can be designed comparatively compactly, especially with a compact floor plan.

The variants of the device described above, as well as their construction and operating aspects, are merely intended to provide a better understanding of the structure, the mode of operation and the properties; they do not limit the disclosure to the embodiments. The figures are schematic, with essential features and effects shown, in some cases significantly enlarged, to illustrate the functions, operating principles, technical embodiments and features. In this context, each mode of operation, principle, technical embodiment and feature disclosed in the figures or in the text can be freely and arbitrarily combined with all claims, each feature in the text and in the other figures, other modes of operation, principles, technical embodiments and features contained in this disclosure or resulting therefrom, so that all conceivable combinations of the described system can be assigned. Combinations between all individual embodiments in the text, i.e. in each section of the description, in the claims and also combinations between different variants in the text, in the claims and in the figures are included. The claims also do not limit the disclosure and thus the possible combinations of all disclosed features with each other. All disclosed features are also explicitly disclosed here individually and in combination with all other features.

1. Device for personalising security or identification objects, in short SI objects (11, 12), with at least a first laser processing station (20), wherein the laser processing station (20) comprises:
a laser unit (30) adapted to personalise an SI article (11, 12) located in a laser processing area (40) by laser irradiation,
a turntable (50) having a first receiving area (51) for receiving a first SI object (11) and having a second receiving area (52) for receiving a second SI object (12); wherein
the turntable (50) is
rotatably supported relative to the laser unit (30) about an axis of rotation (D) so that it can be rotated from a first rotational position to a second rotational position;
wherein
in the first rotational position of the turntable (50), the first SI object (11) arranged in the first receiving area (51) is at least partially located in the laser processing area (40); and wherein
in the second rotational position of the turntable (50), the second SI object (12) arranged in the second receiving area (52) is at least partially located in the laser processing area (40).

2. The apparatus of claim 1, further comprising:
a laser irradiation preparation unit (60) for preparing laser irradiation,
wherein the laser irradiation preparation unit (60) is arranged to detect a position of the second SI object (12) received in the second receiving area (52) in the first rotational position of the turntable (50) and to transmit information about the detected position to the laser unit (30); and wherein
the laser unit (30) is arranged to use the transmitted information as an input quantity in a subsequent laser irradiation of the second SI object (12).

3. The apparatus according to any one of the preceding claims, in which the turntable (50) can be rotated from the first rotational position to the second rotational position by a rotation of 180°±10° about the axis of rotation (D).

4. The apparatus according to any one of the preceding claims, wherein
the turntable (50) has a first support region (81) and a first cover region (82) to form the first receiving region (51), such that the first SI article (11) received in the first receiving region (51) is located between the first support region (81) and the first cover region (82),
a second support portion (83) and a second cover portion (84) to form the second receiving portion (52), such that the second SI object (12) received in the second receiving portion (52) is located between the second support portion (83) and the second cover portion (84).

5. The apparatus according to claim 4, wherein
the first cover area (82) comprises a window area (85) and the second cover area (84) comprises a window area (86), wherein
in the first rotational position of the turntable (50), the first window area (85) at least partially encloses the laser processing area (40).

6. The apparatus of claim 5, wherein
the turntable (50) further comprises a first clamping member (91) reciprocally movable between a clamping position and an open position, wherein
in the clamping position of the first clamping member (91), the first SI article (11) received in the first receiving portion (51) is pressed by the first clamping member (91) against an edge portion of the window portion (85) of the first cover portion (82), so that the first SI object (11) is thereby fixed in the first receiving area (51) and in the open position of the first clamping element (91) the first SI object (11) is movable between the first support area (81) and the first cover area (82), as well as
a second clamping member (92) reciprocally movable between a clamping position and an open position, wherein in the clamping position of the second clamping member (92) the second SI article (12) received in the second receiving portion (52) is pressed against an edge portion of the window portion (86) of the second cover portion (84) by the second clamping member (92), so that the second SI object (12) is—fixed in the second receiving area (52) and in the open position of the second clamping element (92) the second SI object (12) is movable between the second support area (83) and the second cover area (84).

7. The apparatus according to claim 6, wherein
the laser processing station (20) comprises a gripping member (100) adapted to reciprocate the second clamping member (92) between the open position and the clamping position when the turntable (50) is in the first rotational position.

8. The apparatus according to any one of the preceding claims, further comprising
a loading unit (70) which, in the first rotational position of the turntable (50), is arranged to push the second SI object (12) along a first direction (R1) into the second receiving region (52) in order to load the second receiving region (52), and/or to push the second SI object (12) along a second direction (R2), opposite to the first direction (R1), out of the second receiving region (52) in order to unload the second receiving region (52).

9. The apparatus according to any one of the preceding claims, further comprising
at least one further laser processing station (20′) which is designed analogously to the first laser processing station (20);
a transport device (110) which is set up to feed SI objects (11, 12) alternately to the first and the at least one further laser processing station (20, 20′).

10. The apparatus having the features mentioned in claims 9 and 8, wherein
the transport device (110) is arranged to feed the SI objects (11, 12) respectively to the loading unit (70) of the relevant laser processing station (20, 20′).

11. The apparatus according to claim 9 or 10, wherein
the transport device (110) comprises a main transport path (111) and two-distribution transport paths (112) extending
perpendicularly to the main transport path (111), the transport device (110) being arranged to feed the SI objects (11, 12) to the laser processing stations (20, 20′) via the main transport path (111) and the two distribution transport paths (112) and to—transport the SI objects (11, 12) from the laser processing stations (20, 20′) back to the main transport path (111).

12. The apparatus according to claim 11, wherein
the distribution transport paths (112) each lead to at least two laser processing stations (20, 20′).

13. The apparatus according to claim 11 or 12, wherein
the transport apparatus (110) further comprises a separating unit (113), arranged between the main transport path (111) and the distribution transport paths (112), via which the SI objects (11, 12) are transported from the main transport path (111) alternately to the two distribution transport paths (112).

14. A method for personalising security or identification objects, in short SI objects (11, 12) with at least one first laser processing station (20),
comprising the following steps:
(a) placing a first SI article (11) in a first receiving area (51) of a turntable (50) of the laser processing station (20);
(b) placing a second SI article (12) in a second receiving area (52) of the turntable (50);
(c) laser irradiating the first SI item (11) received in the first receiving area (51) for personalisation when the turntable (50) is in a first rotational position by means of a laser unit (30) of the laser processing station (20);
(d) rotating the turntable (50) from the first rotational position to a second rotational position;
(e) laser irradiating the second SI object (12) received in the second receiving area (52) for personalisation when the turntable (50) is in the second rotational position by means of the laser unit (30).

15. The method of claim 14, further comprising the step of:
(f) detecting a position of the second SI object (12) received in the second receiving area (52) when the turntable (50) is in the first rotational position and using information about the position in step (e).

16. The method according to claim 14 or 15, wherein
in step (d) the turntable (50) is rotated by 180°±10°.

17. The method according to any one of claims 14 to 16, wherein—
in step (b), in the first rotational position of the turntable (50), the second SI object (12) is pushed along a first direction (R1) into the second receiving region (52), and/or—
a further step (g), in the first rotational position of the turntable (50), the second SI object (12) is pushed along a second direction (R2) opposite to the first direction (R1) out of the second receiving region (52).

18. The method of any one of claims 14 to 17, further comprising the step of:
(h) transporting SI items and distributing the SI items to several laser processing stations (20, 20′).
